(19) United States
(12) Patent Application Publication
(10) Pub. No.: US 2013/0121140 A1
(43) Pub. Date: May 16, 2013

(54) METHOD OF SHARED MESH PROTECTION SWITCHING

(71) Applicant: Electronics and Telecommunications Research In, Daejeon (KR)

(72) Inventors: Jeong-dong RYOO, Daejeon (KR); Taesik Cheung, Daejeon (KR)

(73) Assignee: Electronics and Telecommunications Research Institute, Daejeon (KR)

(21) Appl. No.: 13/657,225

(22) Filed: Oct. 22, 2012

(30) Foreign Application Priority Data
Oct. 20, 2011 (KR) 10-2011-0107704
Oct. 19, 2012 (KR) 10-2012-0116771

(51) Int. Cl. H04L 12/24

(52) U.S. Cl. CPC H04L 41/0668
USPC 370/228

(57) ABSTRACT

A method of performing shared mesh protection switching in a sharing node is provided. The method includes: receiving a request message from a first terminal node, having detected a signal failure of a working path; copying the request message and forwarding a request message to an adjacent node on a first protection path of a plurality of protection paths; determining whether a sharing resource is available; transmitting, if a sharing resource is available, an available message to a second terminal node forming a pair with the first terminal node; and receiving a response message from the second terminal node, having received the available message from all sharing nodes on the first protection path.

### CROSS-REFERENCE TO RELATED APPLICATION

This application claims priority to and the benefit of Korean Patent Application Nos. 10-2011-0107704 and 10-2012-0116771 filed in the Korean Intellectual Property Office on Oct. 20, 2011 and Oct. 19, 2012, respectively, the entire contents of which are incorporated herein by reference.

### BACKGROUND OF THE INVENTION

(a) Field of the Invention

The present invention relates to a method of performing shared mesh protection switching that shares a protection path,

(b) Description of the Related Art

Protection switching is a method of resuming traffic transmission when traffic transmission is stopped, as a signal failure occurs in a network. A protection switching method is classified into linear protection switching, ring protection switching, and mesh protection switching according to topology of a network.

Linear protection switching operates within a linear protection domain. That is, in a linear protection switching method, both terminals that transmit and si receive traffic and a working path and a protection path that connect the both terminals are defined as a linear protection domain, and by transmitting/receiving a message between terminals according to a protocol, a protection switching function operates.

Mesh protection switching sets a linear protection domain for a point-to-point connection one by one and enables a protection path of a plurality of linear protection domains to share the same network resource, when a plurality of point-to-point connections are formed on a mesh topology network.

That is, mesh protection switching provides a mechanism in which a plurality of linear protection domains efficiently adjust use of a network resource, when the plurality of linear protection domains having different terminals exist in a mesh topology network.

An international telecommunication union-telecommunication standardization sector (ITU-T) performs standardization of shared mesh protection switching to general shared mesh protection switching (G.smp) and the International Engineering Task Force (IETF) is discussing shared mesh protection switching for multi-protocol label switching (hereinafter referred to as MPLS-transport profile (TP)).

In a conventional method of performing shared mesh protection switching, when a terminal node of terminal nodes forming a pair detects a signal failure of a working path or an operator protection switching command, the terminal node transmits a protection switching request to an adjacent sharing node. When a resource exists, a sharing node, having received the protection switching request, finishes work of internal switch setting and resource allocation and forwards a protection switching request to a next sharing node.

Thereafter, after all sharing nodes set the internal switch and allocate a resource, even if the protection switching request arrives at an opposite terminal node, the terminal node having received the protection switching request should change a position of a bridge/selector that transmits/receives traffic to a protection path and notify a terminal node that again requests protection switching of this, and when the terminal node that requests protection switching enables a bridge/selector to advance to a protection path, a protection switching operation is complete.

If there is a sharing node having no resource to allocate among sharing nodes that are positioned on the protection path, the sharing node does not forward a protection switching request to a next node, but notifies a terminal node, having transmitted a protection switching request, that the protection switching request is rejected. In this case, additional work such as work in which the terminal node that has known that the protection switching request was rejected again requests protection switching after a random time period or work in which an operator searches for a third path using a control plane protocol is necessary.

Finally, a protection switching request that is transmitted from a terminal node has a drawback that a protection switching completion time is extended due to serial processing that is forwarded to a next node after all sharing nodes that are positioned on a protection path of another terminal node forming a pair finish the above work.

Further, even if protection switching to a protection path is not complete, when a sharing node cancels sharing resource use of a protection path having a lower priority, when a resource of another sharing node is unavailable, when protection switching is cancelled, even if it is unnecessary to cancel sharing resource use of a protection path having a lower priority, there is a problem that traffic of the protection path is frequently stopped.

### SUMMARY OF THE INVENTION

The present invention has been made in an effort to provide a method of performing shared mesh protection switching having advantages of enabling a terminal node that finds a signal failure of a working path to rapidly transmit a protection switching request to an opposite terminal node and assuring operation of a protection path that uses an existing sharing node until protection switching of a terminal node pair is complete.

An exemplary embodiment of the present invention provides a method of performing shared mesh protection switching in a sharing node that is shared by in a plurality of protection paths The method includes: receiving a request message from a first terminal node, having detected a signal failure of a working path; copying the request message and forwarding a request message to an adjacent node on a first protection path of a plurality of protection paths; determining whether a sharing resource is available; transmitting, if a sharing resource is available, an available message to a second terminal node forming a pair with the first terminal node; and receiving a response message from the second terminal node, having received the available message from all sharing nodes an the first protection path.

The method may further include: copying the response message and forwarding the response message to an adjacent node on the first protection path: and transmitting an unavailable message to another terminal node that is connected to a second protection path of the plurality of protection paths.

The method may further comprise; transmitting, if the sharing resource is unavailable, an unavailable message to the second terminal node forming a pair with the first terminal node; and receiving a first release message from the second terminal node, having received the unavailable message from at least one sharing node of sharing nodes on the first protection path.

The method may further include: copying the first release message and forwarding the first release message to an adjacent node on the first protection path; receiving a second release message from the second terminal node, having received the first release message; and transmitting, when the first and second release messages are received, an available message to a terminal node that is connected to a second protection path of the plurality of protection paths.

The determining of whether a sharing resource is available may further include: determining whether the second protection path of the plurality of protection paths uses the sharing resource; transmitting, if the second protection path uses the sharing resource, an unavailable message to a terminal node pair that are connected to the second protection path: and receiving, copying, and forwarding, after the terminal node pair stop use of the second protection path, an exchanged release message in both directions.

Another embodiment of the present invention provides a method of performing shared mesh protection switching in a first node, having detected a signal failure of a working path of a linear protection domain between terminals including a working path and a protection path that connect the terminal node pair. The method includes: transmitting, when a signal failure of the working path is detected, a request message to a sharing node toward a remaining second terminal node of the terminal node pair; receiving, when the second terminal node, having received the request message that is forwarded through the sharing node receives an available message from all sharing nodes on the protection path, a transmitted response message from the sharing node; and completing protection switching to the protection path.

The method may further include: receiving, when a second terminal node, having received a request message that is forwarded through the sharing node receives an unavailable message from at least one sharing node on the protection node, the forwarded release message from the sharing node; and terminating protection switching to the protection path.

Yet another embodiment of the present invention provides a method of performing shared mesh protection switching in a sharing node that is shared by a plurality of protection paths. The method include: receiving a first release message from the first terminal node, having detected restoration of a signal failure of a working path; copying the first release message and forwarding the first release message to an adjacent node on a first protection path of the plurality of protection paths toward a second terminal node forming a pair with the first terminal node; determining, by the second terminal node, having received the first release message, that the signal failure is restored, and receiving the transmitted second release message; and copying the second release message and forwarding the second release message to the adjacent sharing node toward the first terminal node.

The method may further include transmitting an available message to another terminal node that is connected to the second protection path of the plurality of protection paths.

### BRIEF DESCRIPTION OF THE DRAWINGS

FIG. 1 is a diagram illustrating a shared mesh protection network in which a signal failure has occurred at a working path according to an exemplary embodiment of the present invention.

FIG. 2 is a flowchart illustrating a method of performing shared mesh protection switching when a signal failure has occurred at a working path according to an exemplary embodiment of the present invention.

FIG. 3 is a diagram illustrating a shared mesh protection network in which a signal failure has occurred at a plurality of working paths according to an exemplary embodiment of the present invention.

FIG. 4 is a flowchart illustrating a method of performing shared mesh protection switching when a signal failure has occurred at a plurality of working paths according to an exemplary embodiment of the present invention.

FIG. 5 is a flowchart illustrating a method of performing shared mesh protection switching when a signal failure has occurred at a working path according to an exemplary embodiment of the present invention.

FIG. 6 is a flowchart illustrating a method of performing shared mesh protection switching when a signal failure that has occurred at a working path is restored according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, unless explicitly described to the contrary, the word ‘comprise’ and variations such as “comprises” or “comprising” will be understood to imply the inclusion of stated elements but not the exclusion of any other elements.

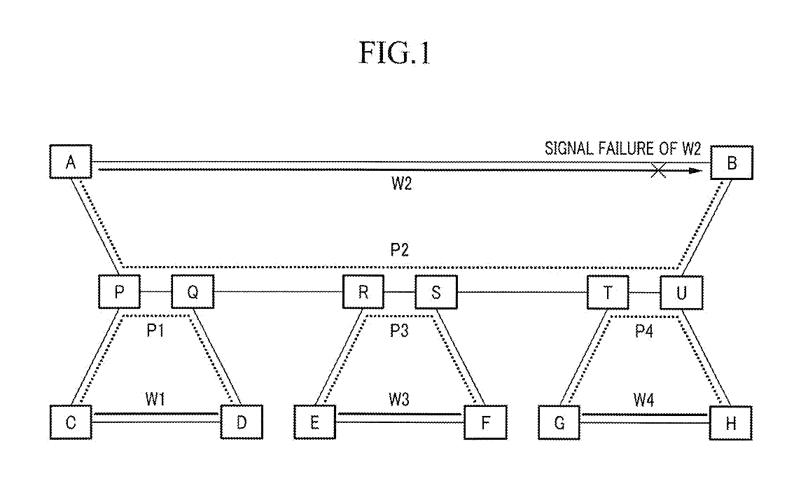

FIG. 1 is a diagram illustrating a shared mesh protection network in which a signal failure has occurred at a working path according to an exemplary embodiment of the present invention.

Referring to FIG. 1, a shared mesh protection network according to an exemplary embodiment of the present invention includes four terminal node pairs (a terminal node pair A-B, a terminal node pair C-D, a terminal node pair E-F, and a terminal node pair G-H), and each terminal node pair is connected to a working path and a protection path. That is, the terminal node pair A-B is connected to a working path W2 and a protection path P2, the terminal node pair C-D is connected to a working path W1 and a protection path P1, the terminal node pair E-F is connected to a working path W3 and a protection path P3, and the terminal node pair G-H is connected to a working path W4 and a protection path P4.

Further, the shared mesh protection network according to an exemplary embodiment of the present invention includes 6 sharing nodes (sharing nodes P, Q, R, S, T, and U). Protection paths of the network share each sharing node pair, wherein the protection path P1 and the protection path P2 share the sharing nodes P and Q, the protection path P3 and the protection path P2 share the sharing nodes R and S, and the protection path P4 and the protection path P2 share the sharing nodes T and U.

In an exemplary embodiment of the present invention, it is assumed that a priority of each protection path is P1>P2>P3>P4, and it is assumed that each terminal node pair operates by bi-directional protection switching.

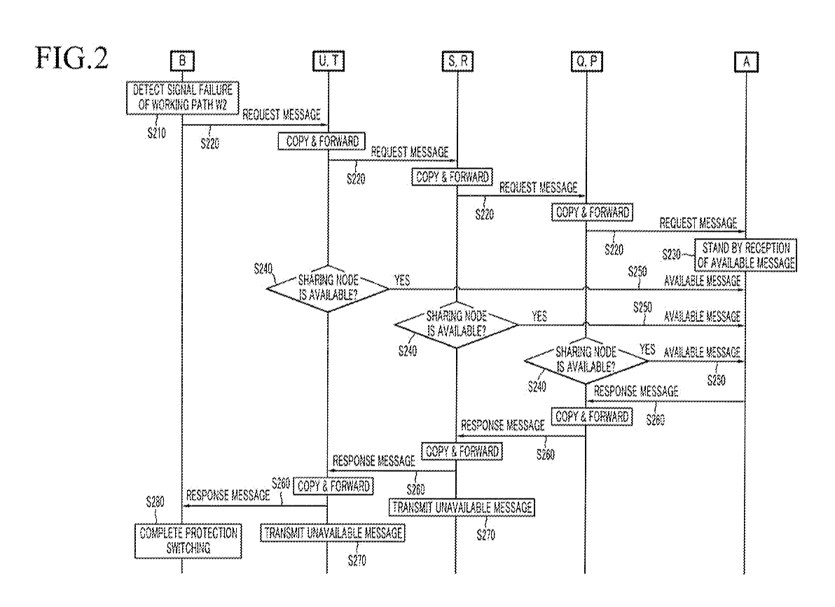

FIG. 2 is a flowchart illustrating a method of performing shared mesh protection switching when a signal failure has occurred at a working path according to an exemplary embodiment of the present invention.

Referring to FIG. 2, when a terminal node B detects a signal failure of the working path W2 (S210), the terminal node B advances a position of a selector that receives traffic to the protection path P2, and transmits a request message to the sharing node U toward a terminal node A (S220).

In this case, the request message is a message in which a terminal node, having detected a protection switching situation, sends a request for use of a protection path to another terminal node. The request message may include information (e.g., priority information, a kind of signal failure, or node identification (ID)) necessary for determining a priority of a protection path that the terminal node requests. A protection switching situation may occur when a signal failure has occurred at a working path or when a network operator instructs protection switching. When a message of existing one-to-one linear protection switching technology is reused, SF (1, 0) SD (1, 0), FS (1, 0), and MS (1, 0) correspond to a request message.

The sharing node U that receives a request message that the terminal node B transmits and all sharing nodes on the protection path P2 up to the terminal node A copy the request message and forward the copied request message to an adjacent node on the connected protection path P2 (copy and forward). The request message that the terminal node B transmits through such a method is rapidly forwarded to the terminal node A. The terminal node A, having received the request message, stands by until it receives an available message or an unavailable message from all sharing nodes on the protection path P2 (S230).

All sharing nodes on the protection path P2 determine whether an available resource exists at the sharing node (S240), and all sharing nodes transmit an available message or an unavailable message to the terminal node A. If there is no protection path that is presently using a sharing node or if a protection path of a lower priority is using a sharing node, all sharing nodes transmit an available message.

Referring to FIG. 2, because all sharing nodes P, Q, R, S, T, and U on the protection path P2 do not use the protection node, all sharing nodes P, Q, R, S, T, and U transmit an available message to the terminal node A (S250). In this case, the available message is directly transmitted from the sharing node that transmits the available message to a destination terminal node of the available message, and nodes between a sharing node that transmits an available message and a destination terminal node of the available message do not perform separate processing of the available message,

When the terminal node A receives an available message from all sharing nodes P, Q, R, S, T, and U on the protection path P2, the terminal node A positions a bridge for traffic transmission and a selector for traffic reception at a protection path and transmits a response message to the terminal node B through the protection path (S260).

In this case, a response message is a message notifying a terminal node having transmitted the request message that it can use the protection path after the terminal node, having received the request message, receives an available message from all sharing nodes that are included in a protection path.

All sharing nodes on the protection path P2, having received the response message, copy and forward the response message.

Thereafter, all sharing nodes on the protection path P2, having copied and forwarded the response message determine whether to transmit an unavailable message to the terminal node through comparison of priorities of the protection path (S270). In this case, the sharing node transmits an unavailable message to a terminal node that is connected to both ends of a protection path having the same priority as or a priority lower than that of a protection path that presently uses the sharing node. The unavailable message is a message notifying that the terminal node cannot use a sharing resource of the sharing node and performs a function of preventing an unnecessary protection switching request for the sharing node. The terminal node, having received an unavailable message from the sharing node, positions a bridge and a selector at the working path and transmits a release message to another terminal node forming a pair with the terminal node. The release message will be described hereinafter.

Referring to FIG. 1, because the protection paths P3 and P4 have a priority lower than that of the protection path P2, the sharing node R transmits an unavailable message to the terminal node E, the sharing node S transmits an unavailable message to the terminal node F, the sharing node T transmits an unavailable message to the terminal node G, and the sharing node U transmits an unavailable message to the terminal node H.

In this case, an unavailable message is transmitted to the terminal node that is connected to both ends of a protection path of the same priority as that of the protection path P2 that is presently using the sharing node. However, because a priority of the protection path P1 is higher than that of the protection path P2, the sharing nodes P and Q do not transmit an unavailable message to the terminal nodes C and D. Even if a signal failure is detected at a working path, the terminal nodes E, F, G, and H, having received the unavailable message, prohibit protection switching to the protection path.

Thereafter, when the terminal node B receives a response message, the terminal node B connects a bridge that transmits traffic to the protection path, and both terminal nodes A and B transmit/receive traffic through the protection path P2, and thus protection switching is complete (S280).

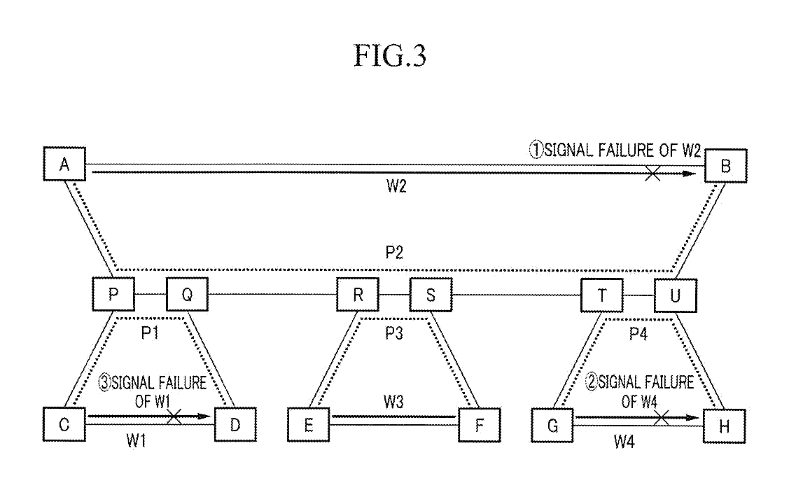

FIG. 3 is a diagram illustrating a shared mesh protection network in which a signal failure has occurred at a plurality of working paths according to an exemplary embodiment of the present invention.

In FIG. 1, a signal failure occurs at the working path W2, and after protection switching to the protection path P2 is complete between the terminal node pair A-B according to the flowchart of FIG. 2, a case where a signal failure first occurs at the working path W4, and a signal failure occurs at the working path W1, is as illustrated in FIG. 3.

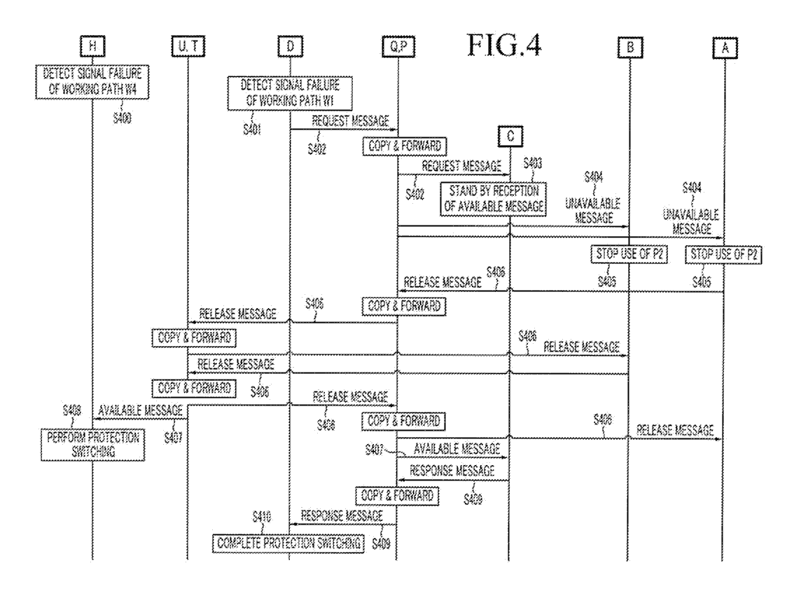

FIG. 4 is a flowchart illustrating a method of performing shared mesh protection switching when a signal failure has occurred at a plurality of working paths according to an exemplary embodiment of the present invention.

Referring to FIGS. 3 and 4, even if the terminal node H detects a signal failure of the working path W4, because the terminal node H has received an unavailable message from the sharing node U (see the flowchart of FIG, 2), protection switching is prohibited, thereby not requesting protection switching (S400).

Thereafter, when the terminal node D detects a signal failure of the working path W1 (S401) the terminal node D advances a position of a selector that receives traffic to the protection path P1 and transmits a request message to the sharing node Q toward the terminal node C (S402).

In this case, the reason why the terminal node D can transmit a request message is that after protection switching to the protection path P2 was complete according to the flowchart of FIG. 2, the terminal node D did not receive an unavailable message from the sharing node Q. In this case, a request message that the terminal node D transmits toward the terminal node C includes information necessary (e.g., priority information, a kind of signal failure, or node ID) for determining a priority of the protection path, as shown in FIG. 2.

Thereafter, the request message is forwarded to the terminal node C with copy and forward methods through the sharing nodes Q and P. The terminal node C, having received the request message, stands by until receiving an available message or an unavailable message from all sharing nodes on the protection path P1 (S403).

The sharing nodes Q and P on the protection path P1 determine whether an available resource exists at the sharing node. Referring to FIG. 3, because the protection path P2 having a priority lower than that of the protection path P1 uses a sharing node, the sharing nodes Q and P transmit an unavailable message to the terminal nodes B and A, respectively (S404).

The terminal nodes A and B, having received an unavailable message, change a position of a bridge and a selector to a working path, stop use of the protection path P2 (S405), and exchange a release message (S406). In FIG. 4, the terminal node A transmits a release message toward the terminal node B, the terminal node B transmits a release message toward the terminal node A, but the terminal nodes A and B may transmit a release message regardless of a release message that another party transmits. Thereafter, even if a signal failure is detected at the working path, the terminal nodes A and B, having received an unavailable message prohibit protection switching to the protection path P2 until again receiving an available message.

In this case, due to restoration of a signal failure of a working path, when protection switching to the protection path is no longer necessary or when the terminal, node receives an unavailable message from the sharing node, the release message is a message that is exchanged with another terminal node forming a pair with the terminal node.

When the terminal node receives an unavailable message, the terminal node positions the bridge and the selector at the working path and exchanges a release message with another terminal node forming a pair. When the release message is arrived in both directions of the sharing node, the sharing node that forwards a release message between the terminal nodes that exchange the release message determines that a sharing resource of the sharing node is available. When existing one-to-one linear protection switching technology is reused, LoP (0, 0) and RR (0, 0) (when an unavailable message is received from the sharing node) or NR (0, 0) (when protection switching to a protection path is unnecessary due to restoration of a signal failure) correspond to a release message.

When the sharing nodes U, T, S, and R forward the release message, having arrived in both directions, the sharing nodes U, T, S, and R recognize that the protection path P2 is no longer used and transmit an available message to the connected terminal nodes E, F, G, and H (S407).

In this case, because the terminal node H, having received the available message from the sharing node U, detects a signal failure of the working path W4 and can use a sharing node on the protection path P4, the terminal node H performs protection switching to the terminal node G and the protection path P4 according to the order that is described with reference to FIG. 2 (S408).

As the sharing nodes P and Q receive the release message in both directions, the sharing nodes P and Q recognize that the terminal node pair A-B no longer use the protection path P2 and transmit an available message to the terminal node C (S407).

Because the terminal node C received an available message from all sharing nodes on the protection path P1, the terminal node C positions a bridge and a selector at the protection path P1 and transmits a response message to the terminal node D (S409).

Thereafter, when the terminal node ID receives the response message, the terminal node D connects the bridge to the protection path, and both terminal nodes C and ID transmit/receive traffic through the protection path P1, and thus protection switching is complete (S410).

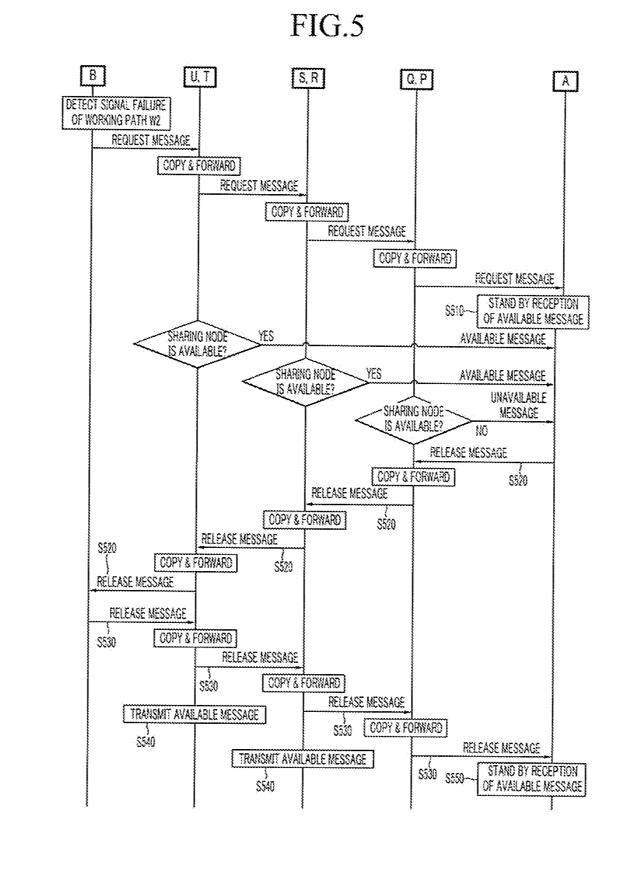

FIG. 5 is a flowchart illustrating a method of performing shared mesh protection switching when a signal failure has occurred at a working path according to an exemplary embodiment of the present invention.

In FIG. 5, unlike a case of FIG. 2, a case where the terminal node A receives an unavailable message from at least one sharing node of sharing nodes on the protection path P2 will be described.

When the terminal node B detects a signal failure of the working path W2, the terminal node B transmits a request message to the sharing node U toward the terminal node A, the request message is copied and forwarded through the sharing node, and arrives at the terminal node A.

Thereafter, the terminal node A stands by for reception of an available message from the sharing node, and when the terminal node A receives an unavailable message from at least one sharing node of sharing nodes on the protection path P2 (S510), and the terminal node A transmits a release message to the sharing node P toward the terminal node B (S520). In FIG. 5, it is assumed that the sharing nodes P and Q transmit an unavailable message to the terminal node A. Thereafter, all sharing nodes on the protection path P2 copy and forward a release message to the terminal node B.

When the terminal node B receives the release message, the terminal node B returns a selector that receives traffic at an original position to the working path, and the terminal node B transmits the release message to the terminal node A (S530). The terminal node pair A and B determine that a bridge and a selector of each node still indicate the working path by exchanging the release message and do not attempt a protection switching request until all sharing nodes receive an available message.

As the sharing node receives a release message from the terminal node B, when the sharing node receives a release message in both directions, the sharing node copies and forwards the release message. As the sharing node receives the release message from the terminal node B, the sharing node receives the release message in both directions and thus the sharing node, having transmitted an available message to the terminal node A, returns a resource that is allocated to the terminal node pair A-B as an available resource, and transmits an available message to the terminal node that is connected to the sharing node (S540). In this case, because the sharing nodes P and Q transmitted an unavailable message to the terminal node A the sharing nodes P and Q do not transmit an available message to the connected terminal node.

The terminal node A, having received a release message from the terminal node B, stands by until receiving an available message from all sharing nodes (S550).

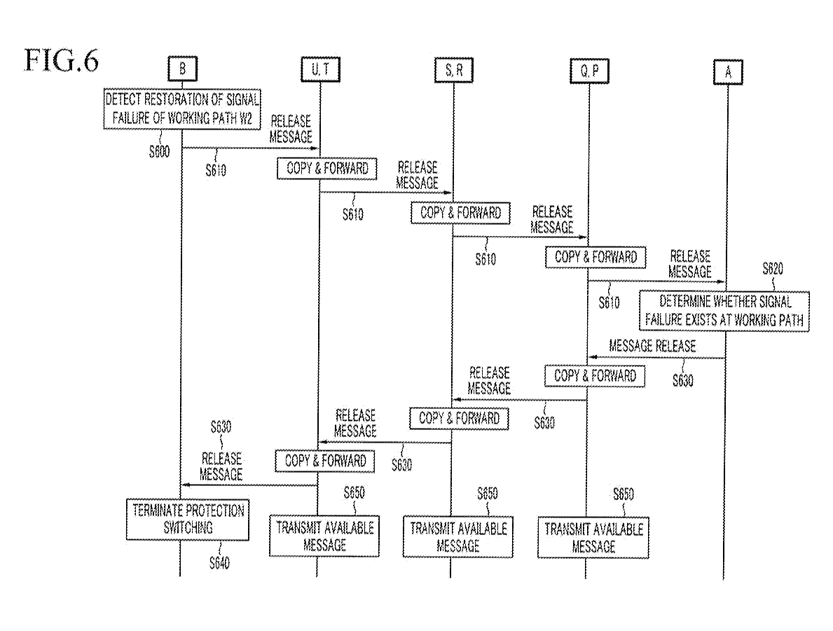

The reason why the sharing node receives a release message from the terminal node B, returns a resource that is allocated to the terminal node pair A-B to an available resource, and transmits an available message to the terminal node pair is to have consistency with a signal failure restoration procedure to be described with reference to FIG. 6 by forwarding an available message after receiving the release message in both directions.

FIG. 6 is a flowchart illustrating a method of performing shared mesh protection switching when a signal failure that has occurred at a working path is restored according to an exemplary embodiment of the present invention.

In a method that is described in FIG, 6, it is assumed that after a signal failure has occurred at the working path W2 the signal failure of the working path W2 is restored, as shown in FIG. 2.

As the signal failure of the working path W2 is restored, when the terminal node B detects restoration of the signal failure (S600), the terminal node B transmits a release message to the terminal node A (S610). All sharing nodes on the protection path P2 copy and forward the release message.

When the terminal node A receives the release message, the terminal node A determines whether a signal failure exists at the working path W2 (S620), and if a signal failure does not exist at the working path W2, the terminal node A changes a position of a bridge and a selector that transmit/receive traffic to the working path W2 and transmits the release message to the terminal node B (S630). All sharing nodes on the protection path P2 again copy and forward the release message.

When the terminal node B receives the release message from the terminal node A, the terminal node 8 changes a position of a bridge and a selector to the working path W2, and traffic is transmitted/received through the working path W2, and thus protection switching to the protection path P2 is terminated (S640).

Even in this case, sharing nodes, having received the release message from both of the terminal node pair, determine that the terminal node pair A-B no longer require a sharing resource and transmit an available message to another terminal node pair having the same priority as or a priority lower than that of the terminal node pair A-B (S650).

According to an exemplary embodiment of the present invention, a terminal node, having found a signal failure of a working path, can rapidly transmit a protection switching request to an opposite terminal node, and the terminal node can assure operation of a protection path using an existing sharing node until protection switching of a terminal node pair is complete.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of performing shared mesh protection switching in a sharing node that is shared by a plurality of protection paths, the method comprising:
receiving a use request message of a first protection path of the plurality of protection paths from a first terminal node, having detected a signal failure of a working path;
copying the use request message and forwarding the use request message to a first adjacent sharing node on the first protection path;
determining whether a sharing resource is available;
transmitting, if a sharing resource is available, an available message of the first protection path to a second terminal node that forms a pair with the first terminal node; and
receiving a response message that is forwarded from a second terminal node, having received the available message from all sharing nodes on the first protection path.

2. The method of claim 1, further comprising:
copying the response message and forwarding the response message to a second adjacent sharing node on the first protection path; and
transmitting an unavailable message to another terminal node that is connected to a second protection path of the plurality of protection paths.

3. The method of claim 2, wherein the first adjacent sharing node is a sharing node adjacent to the second terminal node further than the sharing node on the first protection path, and
the second adjacent sharing node is a sharing node adjacent to the first terminal node further than the sharing node on the first protection path.

4. The method of claim 1, further comprising:
copying, if another sharing node does not exist between the sharing node and the first terminal node on the first protection path, the response message, and forwarding the response message to the first terminal node; and
transmitting an unavailable message to another terminal node that is connected to the second protection path of the plurality of protection paths.

5. The method of claim 1, further comprising:
transmitting, if the sharing resource is unavailable, an unavailable message to the second terminal node forming a pair with the first terminal node; and
receiving a first release message that is forwarded from the second terminal node, having received the unavailable message from at least one of sharing nodes on the first protection path.

6. The method of claim 5, further comprising:
copying the first release message and forwarding the first release message to a second adjacent sharing node on the first protection path;
receiving a second release message that is forwarded from the first terminal node, having received the first release message; and
transmitting, when the first and second release messages are received, an available message to another terminal node that is connected to a second protection path of the plurality of protection paths.

7. The method of claim 1, wherein the determining of whether a sharing resource is available comprises:
comparing, when a second protection path of the plurality of protection paths uses the sharing resource, a priority of third and fourth terminal nodes that are connected to the second protection path with that of the first and second terminal nodes:
transmitting, if a priority of the third and fourth terminal nodes is lower than that of the first and second terminal nodes, an unavailable message to the third and fourth terminal nodes; and
determining, when the third and fourth terminal nodes each receive all exchanged release messages after stopping use of the second protection path, that the sharing resource is available.

8. A method of performing shared mesh protection switching in a first node of a terminal node pair, having detected a signal failure of a working path of a linear protection domain between terminals comprising the working path and a protection path that connect the terminal node pair, the method comprising;
transmitting, when a signal failure of the working path is detected, a use request message of the protection path to a first sharing node of sharing nodes on the protection path toward a second terminal node of the terminal node pair;
receiving a transmitted response message from the first sharing node,
wherein the transmitted response message is a message that is transmitted when the second terminal node having received the use request message receives an available message from all sharing nodes on the protection path; and
completing protection switching to the protection path.

9. The method of claim 8, further comprising:
receiving a release message from the first sharing node; and
terminating protection switching to the protection path,
wherein the release message is a message that is transmitted when a terminal node of a linear protection domain between other terminal nodes receives an unavailable message of the protection path from a sharing node on the protection path.

10. A method of performing shared mesh protection switching in a sharing node that is shared by a plurality of protection paths, the method comprising:
receiving a first release message from a first terminal node, having detected restoration of a signal failure of a working path that connects the first terminal node and a second terminal node;
copying the first release message and forwarding the first release message to a first adjacent sharing node on a first protection path of the plurality of protection paths toward the second terminal node;
receiving a second release message, wherein the second release message is a message that is transmitted by the second terminal node having received the first release message determines that the signal failure is restored: and
copying the second release message and forwarding the second release message to a second adjacent sharing node on the first protection path toward the first terminal node.

11. The method of claim 10, further comprising transmitting, when the first and second release messages are received, an available message to another terminal node that is connected to the second protection path of the plurality of protection paths.
